(19) United States
(12) Patent Application Publication
(10) Pub. No.: US 2006/0076810 A1
(43) Pub. Date: Apr. 13, 2006

(54) Travel headrest comfort cover TM

(76) Inventor: June Nichols, Naperville, IL (US)

Correspondence Address: MICHAEL P. MAZZA, LLC, 686 CRESCENT BLVD., GLEN ELYN, IL, 60137, US

(21) Appl. No.: 10/960,526

(22) Filed: Oct. 7, 2004

(51) Int. Cl. A61G 15/00

(52) U.S. Cl. 297/220

(57) ABSTRACT

A headrest cover made from a substantially static-free material that includes an elastic cord or gathering enabling it to fit seats of different sizes. The headrest cover has multiple insert slits at various heights for receiving pillows within pillow slots at two or more heights. The top pillow slot may be U-shaped or donut-shaped, for example, to support and comfort the traveler's head. The headrest cover may also include side pockets for sachet or freshener inserts and/or for eye glasses, tooth brush or other sundry items, as well as a larger, middle pocket or compartment, for example, for storing a pillow for the back.

### BACKGROUND OF THE INVENTION

The present invention relates to the field of travel headrest covers. More specifically, the invention is directed to a sanitary, travel headrest cover capable of use with seat headrests of different sizes, and also capable of adjusting the height of a pillow contained by the cover.

People who travel via airplanes, buses, trains, or other common carriers often sit in common seating areas where others have sat previously. Travelers' heads, therefore, rest against the same portion of the seats as other travelers before them. New covers for use by individual passengers are typically not provided by carriers for travel seats. Accordingly, it would be desirable to provide a sanitary headrest cover for use by individual travelers.

Removable headrest covers exist, and employ a variety of mechanisms to allow removal. Some removable headrest covers attach to an engagement strip located on the seat by means of hook elements or barbs. Other slip-over headrest covers require a retainer element permanently affixed on the top of, or mounted on, the seat to which the removable headrest cover clasps, such as to a clip retention means mounted on the seat. Known headrest covers are not conducive to travelers who want to maintain the appearance of their hairstyle throughout their trip.

Some seats also have permanently attached headrests with a compartment for insertion of a pillow, which are neither portable nor height-adjustable.

Accordingly, it is an object of the present invention to provide a portable headrest cover capable of adjustable fitting to various seat headrest sizes, and which also allows the traveler to adjust the height of a pillow carried by the headrest cover. It is a further object of the present invention to provide a headrest cover which may be made from a substantially static-free material that will not unduly muss a traveler's hair during a trip. Still another object of the invention is to provide an economic headrest cover which may be disposable, if necessary, and which may be sanitized by its owner.

### SUMMARY OF THE INVENTION

These and other objects are achieved by the present invention. In one preferred embodiment, the headrest cover of the present invention includes an elastic cord or gathering which enables the headrest cover to be fit over seat headrests of different sizes. In a particularly preferred embodiment, the headrest cover, or at least the portion contacting a traveler's head, may but need not be made of a substantially static-free material such as satin. In another embodiment, the headrest cover may also have two or more insert slits for adjustably receiving one or more pillows at varying heights. The headrest cover may also be provided with pockets for sachet or freshener inserts and/or for holding sundry items such as a eyeglasses, comb, hairbrush, toothbrush, etc.

### BRIEF DESCRIPTION OF THE DRAWINGS

FIG. 1 is a front, perspective view of one preferred embodiment of the headrest cover of the invention, with pockets on the rear side of the cover shown in dotted lines;

FIG. 2 is a front, perspective view of a representative travel seat with a headrest and attached cushion;

FIG. 3 is a front, perspective view of the travel seat shown in FIG. 2, including an embodiment of the headrest cover of the present invention attached over the to portion of the seat, including the headrest; and

FIGS. 4 and 5 are front, perspective views of alternative, preferred embodiments of the headrest cover of the present invention which are attached over the top portion, including headrest, of a travel seat.

### DEFINITION OF CLAIM TERMS

The terms used in the claims of the patent as filed are intended to have their broadest meaning consistent with the requirements of law.

“Gathering” means a cord or other resilient means located on the headrest cover of the present invention, enabling the cover to be fit over or at least partially around travel seats of varying sizes in a snug manner.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

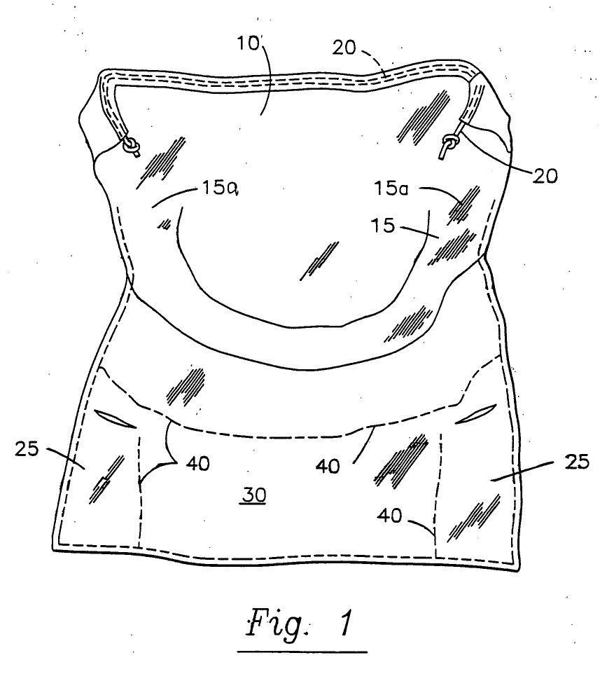

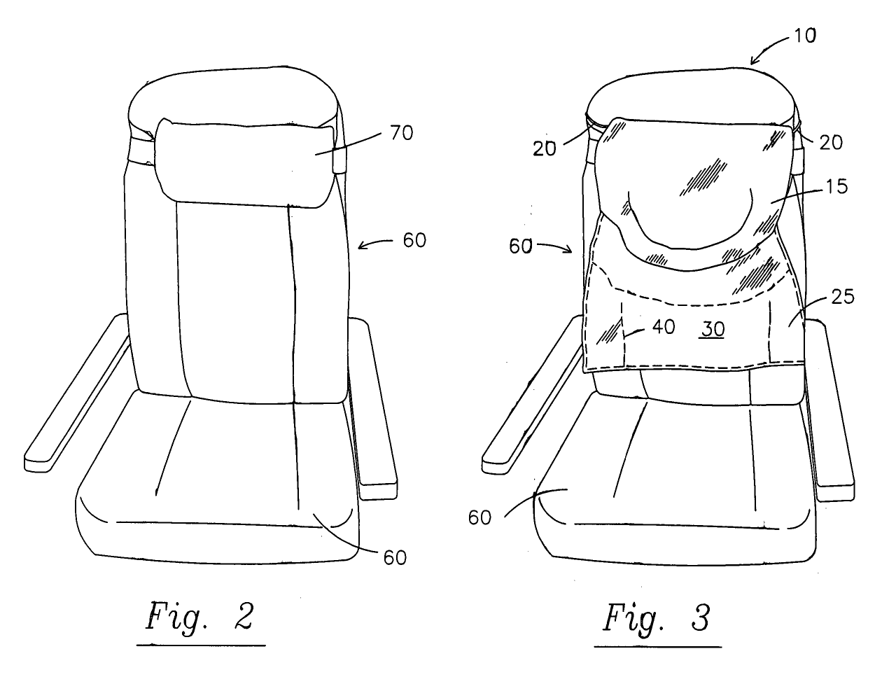

Travelers on common carriers such as airplanes, trains and buses may use the present invention to provide a comfortable, sanitary headrest. Referring first to FIG. 1, one embodiment of the headrest cover of the present invention, generally referred to by using the reference numeral 10, is shown. Headrest cover 10 includes at an upper portion a resilient or elastic cord or gathering 20, which may be stretched to fit the headrest cover over the upper portion of travel seats of various sizes. In the preferred embodiment, the headrest cover 10 may slide over the top of a seat 60 (FIGS. 2-5). Headrest cover 10 may also fit over seats 60 with preexisting headrests 70. Once located over the top of seat 60, elastic cord or gathering 20 preferably snugly fits seat 60, or over the combination of seat 60 and headrest 70, so that headrest cover 10 remains in position for the duration of its use. Elastic cord 20 also allows headrest cover 10 to be easily removed from the seat.

Headrest cover 10 preferably includes a compartment 15 for containing and supporting one or more pillows (not shown), which may be formed using appropriate stitching, for example. Side pockets 25 may also be provided, and again formed using appropriately-located stitching 40. Using stitching 40, a larger, middle pocket or compartment 30 may, but need not be, also provided. Middle pocket 30 may be used to retain a pillow for the back, such as a commonly-sized pillow which may be provided by a carrier such as an airline or train. Of course, the need for and precise location of pockets 25, 30 may be changed from the exemplary embodiments shown in the drawings, as desired.

Referring now to FIGS. 2 and 3, one example of a travel seat 60 is shown, which may or may not have an attached or built-in headrest pillow 70. Headrest cover 10 may be fitted to the top of seat 60, lying over pillow 70, using the elastic cord or gathering 20, so that the traveler may also use a pillow contained within compartment 15 of headrest cover 10.

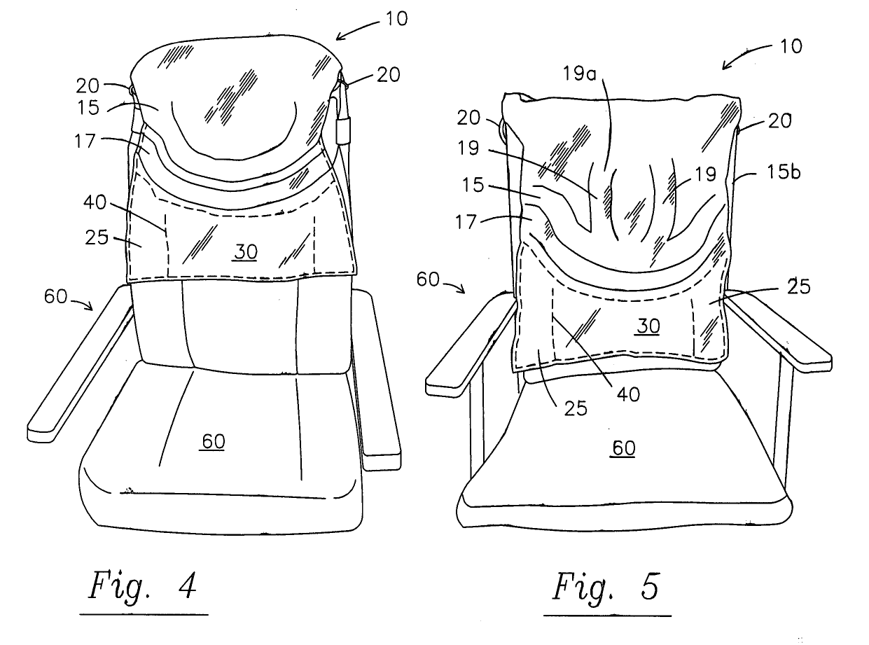

Referring now to FIGS. 4 and 5, preferred embodiments of headrest cover 10 is shown. In the embodiment shown in FIG. 4, upper pillow compartment 15 and lower pillow compartment 17 are provided. This configuration allows the traveler to choose the pillow height desired given the seat size, and to insert the pillow into an appropriate compartment. Referring to FIG. 5, it was found that a generally U-shaped compartment 19, when provided with a pillow, provides the traveler with a great deal of comfort. Alternatively, a donut-shaped or other-shaped compartment may also be used. U-shaped or donut-shaped top pillow compartment 19 may also be contiguous with the pillow slot immediately below it; alternatively, for ease of manufacture, compartment 19 may share space with upper compartment 15, for example, so that a pillow may be inserted into either pillow opening 19a or 15b, for example.

Of course, alternative locations and configurations for these compartments may be provided. Headrest covers 10 may be sold with pillows designed to fit within the pillow compartments. Alternatively, the pillow compartments of headrest cover 10 may be sized to fit pillows provided by the carrier, such as commonly-sized airline pillows.

Headrest cover 10 is preferably made of a substantially static-free material, such as satin, to limit electrostatic attraction to hair, allowing travelers to contact the cover without unduly messing their hair. In one embodiment, only those portions of the cover contacting the traveler may be made of the substantially static-free material. In one embodiment, about two yards of satin was used to make a headrest cover.

Headrest cover 10 may be made of any color of material. However, it may be preferred that the color(s) chosen are different than the color(s) used for the seat, to lessen the likelihood of the traveler forgetting the headrest cover and leaving it on the seat when disembarking.

Referring to FIG. 1, the edges of the headrest cover where the compartment openings 15a are located may be hemmed, to improve the look of these edges and to prevent them from frazzling or unraveling. It was found that one effective method of hemming edges 15a is using buttonhole stitching, which aids in providing headrest cover 10 with a finished look. Buttonhole stitching may also be used to form pockets 25, 30, as well as for forming compartments 15.

Headrest cover 10 may be easily sanitized by heat-treating and/or appropriate washing and drying. The pillow may be sanitized with the cover or separately.

Cover 10 may also include side pockets 25 as well as a middle pocket (not preferred, since this may interfere with the traveler's comfort by unevenly pressuring his/her back). Side pockets 25 may contain sachet or freshener inserts and/or toiletries or other materials that travelers may require during their journey. A draw bag or tote bag may also be used for easy storage of cover 10 during travel.

Other changes and modifications constituting insubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

1. A headrest cover adapted to engage and cover at least a portion of a seat having an upper portion with a headrest and a lower portion with front and rear sides, the front side of the seat having a vertical surface defining a front seat height, comprising:
a gathering enabling the cover to be placed over a headrest portion of seats of varying sizes, and to substantially remain in place during travel; and
two or more pillow compartments positioned adjacent the front side of the seat and located at varying heights on the cover, the pillow compartments enabling insertion and removal of one or more pillows located at two or more heights on the cover along the front seat height, thereby providing a traveler in the seat with additional support and comfort.

2. The headrest cover of claim 1, wherein at least a portion of the cover contacting a traveler's head during seated travel comprises a substantially static-free material.

3. The headrest cover of claim 2, wherein the substantially static-free material comprises satin.

4. The headrest cover of claim 1, wherein the gathering comprises one or more elastic cords located at an upper portion of the headrest cover when the cover is placed over the headrest portion of the seat.

5. The headrest cover of claim 1, wherein prior to placement over a headrest of a seat the cover is sanitized.

6. The headrest cover of claim 1, wherein the two or more pillow compartments comprise upper and lower pillow compartments, with the upper pillow compartment being adjacent to and closer to the headrest than the lower pillow compartment, and with each of the compartments being substantially parallel to the other.

7. The headrest cover of claim 1, wherein one or more of the pillow compartments comprises a generally U-shaped or donut-shaped compartment when viewed from the side of the seat.

8. The headrest cover of claim 1, further comprising one or more side pockets.

9. The headrest cover of claim 8, wherein the one or more side pockets comprise a sachet or carry a freshener.

10. The headrest cover of claim 1, further comprising a compartment located to support a traveler's back.

11. The headrest cover of claim 1, wherein the color of the cover is selected to be substantially different than the color of the seat.

12. A headrest cover adapted to engage and cover at least a portion of a seat having an upper portion with a headrest and a lower portion with front and rear sides, the front side of the seat having a vertical surface defining a front seat height, comprising:
a gathering enabling the cover to be placed over a headrest portion of seats of varying sizes, and to substantially remain in place during travel; and
two or more pillow compartments positioned adjacent the front side of the seat and located at varying heights on the cover, the pillow compartments enabling insertion and removal of one or more pillows located at two or more heights on the cover along the front seat height, thereby providing a traveler in the seat with additional support and comfort;
wherein at least that portion of the cover normally contacting a traveler's head during seated travel comprises a substantially static-free material.

13. The headrest cover of claim 12, wherein the substantially static-free material comprises satin.

14. The headrest cover of claim 13, further comprising one or more side pockets located at a front seat height below the pillow compartments for carrying air fresheners.

15. (canceled)

16. The headrest cover of claim 5, wherein prior to placement over a headrest of a seat the cover is sanitized by at least heating.
